(19) United States
(12) Patent Application Publication
(10) Pub. No.: US 2024/0406489 A1
(43) Pub. Date: Dec. 5, 2024

(54) METHOD FOR PROCESSING VIRTUAL ITEM AND ELECTRONIC DEVICE

(71) Applicant: BEIJING DAJIA INTERNET INFORMATION TECHNOLOGY CO., LTD., Beijing (CN)

(72) Inventor: Yunfei YIN, Beijing (CN)

(21) Appl. No.: 18/509,795

(22) Filed: Nov. 15, 2023

(30) Foreign Application Priority Data
Jun. 2, 2023 (CN) 202310653167.7

(51) Int. Cl. H04N 21/431; H04N 21/2187; H04N 21/27; H04N 21/472; H04N 21/478

(52) U.S. Cl. CPC H04N 21/4316; H04N 21/2187; H04N 21/27; H04N 21/472; H04N 21/478; A63F 13/537

(57) ABSTRACT

Provided is a method for processing virtual items in a live-streaming process. The method includes: acquiring, in response to an interactive content live-streaming instruction to a third-party application, an item material of at least one virtual item associated with the third-party application, wherein the item material of the virtual item is bound to a preset item position; and displaying an interactive content live-streaming interface corresponding to the third-party application and displaying the item material of the virtual item at the preset item position in the interactive content live-streaming interface.

This application is based on and claims priority to Chinese Patent Application No. 202310653167.7, filed on Jun. 2, 2023, the disclosure of which is herein incorporated by reference in its entirety.

### TECHNICAL FIELD

The present disclosure relates to the field of Internet technologies, and in particular, relates to a method for processing virtual items and an electronic device.

### BACKGROUND

With the development of Internet technologies and the increasing popularity of smart terminals, more and more users are engaged in various online entertainments over phones and other smart devices, for example, viewing live-streaming and the like on phones. In the process of live-streaming, viewers can make online interactions by gifting virtual items and the like. In the related art, the virtual item panel of the live-streaming room often presents a generic virtual item set by the live-streaming platform, and in live-streaming of interactive content of a third-party application such as gaming, the generic virtual items are not associated with the third-party application.

### SUMMARY

Embodiments of the present disclosure provide a method for processing virtual items and an electronic device.

According to one aspect of the embodiments of the present disclosure, a method for processing virtual items is provided. The method includes: acquiring, in response to an interactive content live-streaming instruction to a third-party application, an item material of at least one virtual item associated with the third-party application, wherein the item material of the virtual item is bound to a preset item position; and displaying an interactive content live-streaming interface corresponding to the third-party application and displaying the item material of the virtual item at the preset item position in the interactive content live-streaming interface.

According to another aspect of the embodiments of the present disclosure, an electronic device is provided. The device includes a processor; and a memory, configured to store one or more instructions executable by the processor; wherein the processor, when loading and executing the one or more instructions, is caused to: acquire, in response to an interactive content live-streaming instruction to a third-party application, an item material of at least one virtual item associated with the third-party application, wherein the item material of the virtual item is bound to a preset item position; and display an interactive content live-streaming interface corresponding to the third-party application and displaying the item material of the virtual item at the preset item position in the interactive content live-streaming interface.

According to still another aspect of the embodiments of the present disclosure, a non-transitory computer-readable storage medium is provided. The one or more instructions in the storage medium, when loaded and executed by a processor of an electronic device, cause the electronic device to: acquire, in response to an interactive content live-streaming instruction to a third-party application, an item material of at least one virtual item associated with the third-party application, wherein the item material of the virtual item is bound to a preset item position; and display an interactive content live-streaming interface corresponding to the third-party application and display the item material of the virtual item at the preset item position in the interactive content live-streaming interface.

### BRIEF DESCRIPTION OF DRAWINGS

FIG. 1 is a schematic diagram of an application environment according to some embodiments of the present disclosure;

FIG. 2 is a flowchart of a method for processing virtual items according to some embodiments of the present disclosure;

FIG. 3 is a schematic diagram of an interactive content live-streaming interface according to some embodiments of the present disclosure;

FIG. 4 is a schematic diagram of another interactive content live-streaming interface according to some embodiments of the present disclosure;

FIG. 5 is a block diagram of an apparatus for processing virtual items according to some embodiments of the present disclosure; and

FIG. 6 is a block diagram of an electronic device for processing virtual items according to some embodiments of the present disclosure.

### DETAILED DESCRIPTION

It should be noted that the user information (including, but not limited to, user device information, user personal information, or the like) and data (including, but not limited to, data used for display, data used for analytics, or the like) to which this disclosure relates are authorized by the user or fully authorized by the parties.

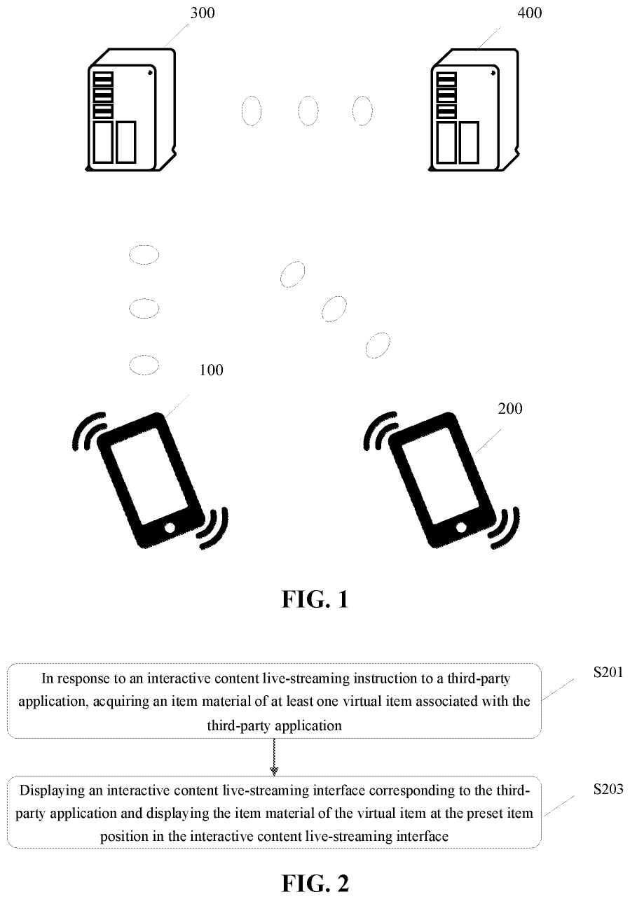

Referring to FIG. 1, FIG. 1 is a schematic diagram of an application environment according to some embodiments of the present disclosure. The application environment includes a first terminal 100, a second terminal 200, a first server 300, and a second server 400.

In some embodiments, the first terminal 100 is an anchor terminal of the live-streaming platform side. The second terminal 200 is a viewer of the live-streaming platform side. The first server 300 is a server of the live-streaming platform side. The second server 400 is an application server corresponding to a third-party application that is required to perform live-streaming of interactive content on the live-streaming platform.

In some embodiments, the first terminal 100 and the second terminal 200 include, but are not limited to, smartphones, desktop computers, tablet computers, laptops, smart speakers, digital assistants, augmented reality (AR)/virtual reality (VR) devices, smart wearable devices, and other types of electronic devices, or software run in the above electronic devices, such as applications and the like. In some embodiments, the operating system run on the electronic device includes, but is not limited to, Android, IOS, Linux, Windows, and the like.

In some embodiments, the first server 300 and the second server 400 are independent physical servers, or a server cluster or distributed system including a plurality of physical servers, or a cloud server providing cloud computing services.

In some embodiments, the user triggers, based on the first terminal 100, a live-streaming start instruction to the interactive content corresponding to the third-party application. Schematically, the first terminal 100 also runs a third-party application, which is an application, or an applet, or the like. In some embodiments, in response to triggering the live-streaming start instruction, the third-party application sends the interactive content information to the second server 400, the second server 400 sends the interactive content screen to the first server 300, and then the first server 300 sends the interactive content information to the first terminal 100 and the second terminal 200, such that the first terminal 100 and the second terminal 200 display the interactive content live-streaming screen corresponding to the third-party application.

Furthermore, it should be noted that what is shown in FIG. 1 is only one application environment provided by the present disclosure, and in actual utilization, it is capable of including other application environments, such as including more terminals.

In the embodiments of the present specification, the first terminal 100, the second terminal 200, the first server 300, and the second server 400 are capable of being directly or indirectly connected via a wired or wireless communication manner, which is not limited in the present disclosure.

In the related art, the virtual item panel of the live-streaming room often presents a generic virtual item set by the live-streaming platform, and in live-streaming of interactive content of a third-party application, the generic virtual items from the live-streaming platform are separated or not associated with the third-party application. For example, when a third-party application is a gaming application, the generic virtual items of the live-streaming platform may not be related to the gaming such that the users cannot participating in interaction service of the gaming based on the generic virtual items, which can affect the interactions among the users (such as anchors and viewers) in the live-streaming events.

FIG. 2 is a flowchart of a method for processing virtual items illustrated according to some embodiments. The method is applied to a terminal such as the first terminal, the second terminal, and the like. As shown in FIG. 2, the method includes the following processes.

In S201, in response to an interactive content live-streaming instruction to a third-party application, an item material of at least one virtual item associated with the third-party application is acquired.

In some embodiments, the item material of each of the above virtual items is bound to one of the at least one preset item position, or the item material of each of the virtual items is bound to a preset item position. In some embodiments, the at least one preset item position is a region in the interactive content live-streaming interface configured to display the item material. In some embodiments, the above interactive content live-streaming instruction is an instruction to turn on the live-streaming of interactive content screen for the third-party application. In some embodiments, the item material of the virtual item includes description on a virtual item, such as material capable of describing the virtual item such as an item icon of the virtual item, a corresponding item name of the virtual item, and the like.

In some embodiments, the at least one virtual item associated with the third-party application is at least one virtual item matched with at least one interaction service corresponding to the third-party application. The virtual item matched with the interaction service is configured to trigger processing the interaction service. In some embodiments, the interaction service is matched with one or more virtual items. The above at least one interaction service is at least one interaction operation during the operation of the third-party application. In some embodiments, the third-party application is a game application, a painting application, a PPT (Power Point) creation application, and the like. In some embodiments, taking the third-party application as a game application as an example, the at least one interaction service is at least one game interaction service (play) during the game process, such as a recruit operation, an accelerate operation, and the like. In some embodiments, taking the third-party application as a painting application as an example, the at least one interaction service is at least one painting interaction service during the painting process, such as a composition operation, a color operation, and the like. Taking the third-party application as a PPT creation application as an example, the at least one interaction service is at least one creation interaction service during the PPT creation process, such as a form creation operation, a hyperlink creation operation, and the like.

In some embodiments, the above item material is provided by the third-party application side, and in some embodiments, the third-party application provides the above item material in response to triggering the interactive live-streaming instruction, or the above item material is provided in advance prior to triggering the interactive live-streaming instruction, for example, when the third-party application is accessed to the live-streaming platform.

In S203, an interactive content live-streaming interface corresponding to the third-party application is displayed, and the item material of the virtual item is displayed at the preset item position in the interactive content live-streaming interface.

In some embodiments, the above interactive content live-streaming interface is a live-streaming interface of the interactive content screen corresponding to the third-party application. In some embodiments, in the case that the third-party application is a game application, the interactive content screen is a screen during the game operation interaction process. In the case that the third-party application is a painting application, the interactive content screen is a screen during the painting operation interaction process. In the case that the third-party application is a PPT creation application, the interactive content screen is a screen during the PPT creation interaction process. In some embodiments, an item material displayed at a preset item position is configured to trigger an interaction operation based on a corresponding virtual item.

In some embodiments, in the case that the above item material is provided by the third-party application side in response to triggering the interactive live-streaming instruction, the above method further includes:

sending, in response to the interactive content live-streaming instruction, a preset item identification of the preset item position to an application server of the third-party application.

Accordingly, the above acquiring the item material of the at least one virtual item associated with the third-party application includes: acquiring the item material of the virtual item and the preset item identification corresponding to the item material provided by the application server.

Accordingly, the above displaying the item material of the virtual item at the preset item position in the interactive content live-streaming interface includes:

displaying the item material of the virtual item at the preset item position in the interactive content live-streaming interface based on the preset item identification corresponding to the item material.

In some embodiments, the preset item identification corresponding to each of the preset item positions is sent via the live-streaming server to the application server corresponding to the third-party application. In some embodiments, the preset item identification corresponding to each of the preset item positions is identification information of the preset item position. In some embodiments, the application server, in combination with the actual application requirements, matches each of the virtual items with a corresponding preset item position by establishing a correspondence between the item material of the virtual item and a preset item identification.

In some embodiments, the above at least one preset item position is a position of a generic virtual item in the live-streaming platform, i.e., in a scenario in which the item material of the generic virtual item is replaced with the item material of the virtual item associated with the third-party application, the preset item position is provided with a corresponding amount of item resources (i.e., the amount of virtual resources equivalent to the virtual item). In some embodiments, in the case that the live-streaming server sends a preset item identification to the application, the live-streaming server may send the amount of item resources corresponding to each of the preset item identifications, such that the application server, in combination with the amount of item resources, establishes a correspondence between the item material of the virtual item and the corresponding preset item identification.

In some embodiments, the above at least one preset item position is individually created for the virtual items associated with the third-party application. Accordingly, the amount of item resources corresponding to the preset item position is preset by the live-streaming platform or provided by the third-party application. In some embodiments, in the case that the amount of item resources is provided by the third-party application, the above acquiring the item material of the virtual item and the preset item identification corresponding to the item material provided by the application server includes: acquiring the item material of the virtual item provided by the application server, the preset item identification corresponding to the item material, and the amount of item resources corresponding to the virtual item.

In some embodiments, the application server sends the item material, the amount of item resources, and the like to the ends (the anchor terminal and the viewer terminal) through the live-streaming server. In some embodiments, the live-streaming server reviews the item material prior to sending the item materials to ensure the quality and safety of the sent item material.

In some embodiments, in combination with the preset item identification corresponding to each of the item material, the item material of the virtual item is displayed at the preset item position corresponding to the preset item identification in the interactive content live-streaming interface.

In the above embodiments, by sending the preset item identification corresponding to each of the preset item positions to the application server corresponding to the third-party application, and by corresponding each of the item material to a preset item identification while providing the item material of the virtual item by the application server, the binding of the item material to the preset item positions can be realized, thus associated virtual items can be provided to the third-party application corresponding to the interactive content in the live-streaming room, and the correlation and adaptability between the virtual items in the live-streaming room and the interactive content of the live-streaming are enhanced.

In some embodiments, the at least one of the above preset item positions is in a visible interactive region of the interactive content live-streaming interface and/or in a virtual item panel corresponding to the interactive content live-streaming interface. Schematically, the terminal displaying the interactive content live-streaming interface corresponding to the third-party application includes at least one of: displaying at least one preset item position in a visible interactive region of the interactive content live-streaming interface; and displaying at least one preset item position in a virtual item panel of the interactive content live-streaming interface.

In some embodiments, the visible interactive region is a visible region in the interactive content live-streaming interface. Accordingly, during the display of the interactive content live-streaming interface, the item material of the at least one virtual item associated with the third-party application can be displayed in the at least one preset item position without any additional operation of the user.

In some embodiments, control information is displayed in a visible panel in the interactive content live-streaming interface (the control information is correspondingly displayed in the virtual item panel). Accordingly, the display of the virtual item panel including the at least one preset item position is triggered by clicking on the panel to display the control information, or the like. Accordingly, in the case that the virtual item panel is displayed, the corresponding item material is rendered at the at least one preset item position.

In the above embodiments, by providing the at least one preset item position for displaying the item material in the visible interactive region of the interactive content live-streaming interface and/or the corresponding virtual item panel of the interactive content live-streaming interface, the flexibility of the interaction of the virtual item can be greatly improved, and in the case that the visible interactive region is provided with the at least one preset item position, the convenience of the user's interaction based on the virtual item can be further improved.

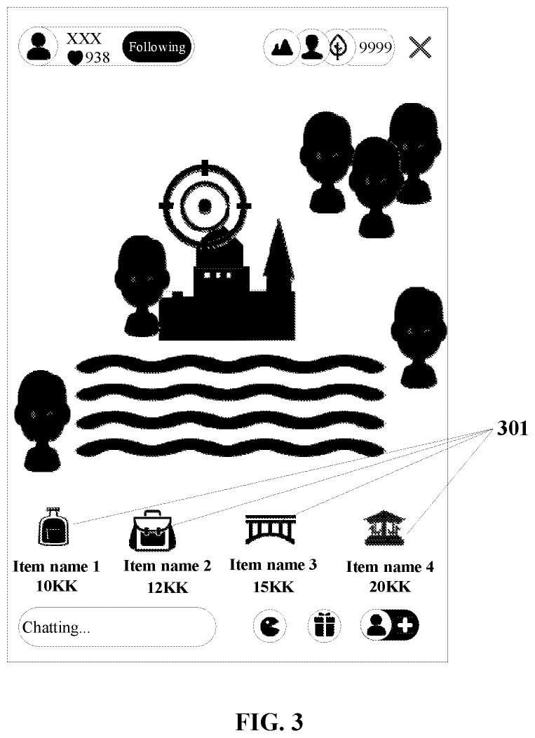

In some embodiments, the third-party application is a game application, and the at least one preset item position is in the visible interactive region of the interactive content live-streaming interface. For example, FIG. 3 is a schematic diagram of an interactive content live-streaming interface according to some embodiments of the present disclosure. As shown in FIG. 3, the information corresponding to 301 is the item material of a plurality of virtual items displayed in the plurality of preset item positions. The item material includes an item name and an item icon. In some embodiments, the amount of item resources corresponding to the virtual items is displayed in the preset item position as illustrated in FIG. 3. In the illustrated example, five item materials are displayed at a bottom region of the interactive content live-streaming interface.

In some embodiments, the item material corresponding to the current interaction service (the currently running interaction service or the current interaction operation) is displayed in the interactive content live-streaming interface, and the item material is continuously updated as the interaction service is updated. Accordingly, the above at least one virtual item is matched with the at least one interaction service corresponding to the third-party application, the above at least one interaction service is a first interaction service currently running in the third-party application, and the above at least one virtual item is at least one first virtual item matched with the first interaction service.

Further, displaying the item material of the virtual item at the preset item position in the interactive content live-streaming interface includes: displaying, at the preset item position in the interactive content live-streaming interface, the item material of the first virtual item.

In some embodiments, the above method further includes:

updating the item material of the first virtual item displayed at the preset item position in the interactive content live-streaming interface to an item material corresponding to a second virtual item, in response to the interaction service currently running in the third-party application being updated from the first interaction service to a second interaction service.

In some embodiments, the second virtual item is matched with the second interaction service.

In the above embodiments, displaying the item materials of the virtual items currently used for conducting the interaction in the live-streaming room based on the interaction service currently running in the third-party application can greatly enhance the adaptability between the virtual items and the interactive content of the live-streaming during the live-streaming, increase the correlation between the interaction based on the virtual items and the interaction service of the third-party application, and allow the user to participate in the interaction service of the third-party application based on the interaction of the virtual items, such that the participation rate of the interaction service can be increased and the interactivity based on the virtual items can be enhanced, and the live-streaming atmosphere and the live-streaming interactivity can be enhanced.

In some embodiments, in the case that the third-party application corresponds to a plurality of interaction services, the item material of the virtual items matched with the plurality of interaction services is displayed together. In some embodiments, service identification information of the matching interaction services is displayed in the position where the item material of the virtual item is disposed, such that the user can know the virtual items corresponding to the interaction services. Accordingly, the above at least one interaction service includes a plurality of interaction services during running of the third-party application. Displaying the item material of the virtual item at the preset item position in the interactive content live-streaming interface includes:

displaying, at the preset item position in the interactive content live interface, item material of the virtual item and matched service identification information corresponding to the virtual item.

In some embodiments, the matched service identification information is configured to identify the interaction service matched with the virtual item.

In the above embodiments, when displaying the item material of the virtual item at the preset item position corresponding to the virtual item, the matched service identification information corresponding to the item material is also displayed, which is convenient for the user to know the virtual items corresponding to different interaction services. Thus, it is more convenient for the user to interact based on the virtual items in the case that the item material of virtual items corresponding to a plurality of interaction services is synchronously displayed.

In some embodiments, according to the object classification attributes, different item material is set for objects in different classifications, such that the user's personalized experience is enhanced. Accordingly, each of the item material of the virtual items includes a target classification item material of the virtual item. The target classification item material is a classification item material matched with an object classification attribute of a target object of a plurality of classification item materials corresponding to the virtual item. The target object is a user account of a display terminal corresponding to the interactive content live-streaming interface. Accordingly, acquiring the item material of the at least one virtual item associated with the third-party application includes:

acquiring a target classification item material of the virtual item.

Further, displaying the item material of the virtual item at the preset item position in the interactive content live-streaming interface includes:

displaying, at the preset item position in the interactive content live-streaming interface. the target classification item material of the virtual item.

In some embodiments, first matching information provided by an application server of the third-party application is acquired. The first matching information indicates matching between each of the plurality of classification item materials corresponding to the virtual item and a matching object classification attribute.

In some embodiments, the third-party application uploads the first matching information to the live-streaming server in advance, and accordingly, during the live-streaming, the live-streaming server combines the first matching information to issue different classification item material for objects with different object classification attributes. The object classification attributes are object attributes configured to classify objects, such as the team of the objects in the two-party confrontation game application. In some embodiments, in the case that the two parties correspond to different virtual images, the virtual image of one party is a horse, the virtual image of another party is a dragon, the object material corresponding to the object belonging to the team whose virtual image is the horse includes horse elements, and the object material corresponding to the object belonging to the team whose virtual image is the dragon includes dragon elements. In some embodiments, taking the painting application as an example, the object classification attribute is the painting genre of the object. For example, the object material corresponding to the object of the impressionist school includes an impressionist pattern, and the object material corresponding to the object of the abstractionist school includes an abstractionist pattern.

In some embodiments, the live-streaming server, upon receiving the first matching information, reviews the first matching information to ensure the reasonableness and safety of the classification item material distribution based on the first matching information.

In the above embodiments, in combination with the first matching information between the classification item material and the matching object classification attribute provided by the third-party application, different classification item material can be distributed to objects in different classifications based on the object classification attribute, and a personalized configuration of item material in different classification object dimensions can be realized, such that the richness of the item material and the personalized experience of the user are improved, and the user's enthusiasm and participation in the interaction based on the virtual items can be enhanced, and the live-streaming atmosphere and interactivity are improved.

In some embodiments, unique item material is displayed for a particular user. Accordingly, the item material of the virtual item includes a designated item material. The designated item material is an item material matched with a preset object. The preset object is an object whose application interaction attribute is a preset application interaction attribute.

Acquiring the item material of the at least one virtual item associated with the third-party application includes:

acquiring the designated item material in response to the application interaction attribute corresponding to a target object is the preset application interaction attribute. The target object is a user account of a display terminal corresponding to the interactive content live-streaming interface.

Displaying the item material of the virtual item at the preset item position in the interactive content live-streaming interface includes:

displaying, at the preset item position in the interactive content live-streaming interface, the designated item material.

In some embodiments, second matching information provided by an application server of the third-party application is acquired. The second matching information indicates matching between the designated item material and the preset application interaction attribute.

In some embodiments, the third-party application uploads the second matching information to the live-streaming server in advance, and accordingly, during the live-streaming, the live-streaming server sends, in conjunction with the second matching information, the designated item material to the object whose corresponding application interaction attribute is the preset application interaction attribute. In some embodiments, the live-streaming server sends the ordinary item material associated with the third-party application to the object whose corresponding application interaction attribute is the non-preset application interaction attribute. material. The application interaction attribute is an attribute that can reflect the interaction characteristics of the object in the third-party application, such as the object's interaction achievement, interaction habit, special identity, and the like, in the third-party application. In some embodiments, in the case that the third-party application is a game application, for example, the object ranked at a top preset number of places in the game (the preset application interaction attribute) is the preset object. In some embodiments, the third-party application is a PPT creation application, for example, the object with the top preset number (preset application interaction attribute) of virtual items given away during the PPT creation process is the preset object. In some embodiments, the designated item material is an item material that is different from the ordinary item material, for example, a special identification such as VIP is added to the ordinary item material.

In some embodiments, the live-streaming server, upon receiving the second matching information, reviews the second matching information in advance so as to enhance the reasonableness and safety of issuing the designated item material based on the second matching information.

In the above embodiments, in combination with the second matching information between the designated item material provided by the third-party application and the preset application interaction attributes, the designated item material can be issued for the object whose corresponding application interaction attribute is the preset application interaction attribute, such that a personalized configuration of the item material in a single object dimension is realized. Thus, not only the richness of the item material is improved, the user's enthusiasm and participation in the interaction based on the virtual item can be improved as well, and the live-streaming atmosphere and interactivity are improved.

In some embodiments, the at least one virtual item is matched with at least one interaction service corresponding to the third-party application. Accordingly, the virtual item corresponds to at least one preset interaction effect under the interaction service is matched by the virtual item. In some embodiments, the method further includes:

updating an interactive content screen in the interactive content live-streaming interface in response to triggering an item interaction instruction based on an item material corresponding to a target virtual item.

In some embodiments, the above interactive content screen is updated based on a target interaction effect corresponding to the target virtual item, the above target virtual item is any virtual item of the at least one virtual item, and the target interaction effect is a preset interaction effect of the at least one preset interaction effect corresponding to the target virtual item. Any one of the preset interaction effects of the virtual item in the matched interaction service represents the influence of the interaction based on the virtual item in the live-streaming room (an interaction of giving a virtual item to the anchor of the live-streaming room) on the matched interaction service. In some embodiments, taking the third-party application being a game application as an example, it is assumed that the target virtual item is a virtual item X, and the interaction service matched with the virtual item X is a recruiting service. The preset interaction effects of the virtual item X in the matched interaction service include: 1. giving one virtual item X can recruit a small soldier; 2. giving five virtual items X can evolve the small soldier into a large soldier. In some embodiments, in the case that the item interaction instruction instructs that one virtual item X is given, accordingly, the target interaction effect is to recruit one small soldier. In the case that the item interaction instruction instructs that five virtual items X are given, the target interaction effect is to evolve the corresponding small soldier into a large soldier. In the case that the third-party application is a painting application, for example, assuming that the target virtual item is a virtual item Y, and the interaction service matched with the virtual item Y service is a coloring service. The preset interaction effects of the virtual item Y in the matched interaction service include: 1. giving one virtual item Y to increase the coloring speed by 2 times; 2. giving two virtual items Y to increase the coloring speed by 5 times. In some embodiments, in the case that the item interaction instruction instructs that one virtual item Y is given, accordingly, the target interaction effect can increase in the coloring speed by 2 times. In the case that the item interaction instruction instructs that two virtual items X are given, the target interaction effect can increase the coloring speed by 5 times.

In some embodiments, updating the interactive content screen in the interactive content live-streaming interface in response to triggering the item interaction instruction based on the item material corresponding to the target virtual item includes:

sending the item interaction instruction to an application server of the third-party application in response to the item interaction instruction, wherein the item interaction instruction indicates performing a service interaction operation corresponding to the target interaction effect to update the interactive content screen; and

updating the interactive content screen in the interactive content live-streaming interface based on updated interactive content information in response to receiving the updated interactive content information provided by the application server.

In some embodiments, the terminal sends the item interaction instruction to the application server via the live-streaming server. The application server performs the service interaction operation corresponding to the target interaction effect in response to the item interaction instruction. In some embodiments, the item interaction instruction carries a preset item identification, and accordingly, the application server determines the target interaction effect in combination with the preset item identification to perform the corresponding service interaction operation.

In practical application, in the case that the interactive content of the application server is updated, the updated interactive content information is transmitted to the live-streaming server. Accordingly, the live-streaming server sends the updated interactive content information, and the terminal updates the interactive content screen in the interactive content live-streaming interface based on the updated interactive content information. In some embodiments, the updated interactive content information is the interactive content information corresponding to the third-party application in the case that the service interaction operation corresponding to the target interactive effect is performed.

In the above embodiments, by sending the service interaction operation used to instruct performing the target interaction effect to the application server, the interactive content screen in the interactive content live-streaming interface is updated. Thus, it is convenient for the application server to promptly send the interactive content information upon updating based on the service interaction operation, and the interactive content screen in the interactive content live-streaming interface can be updated promptly.

In some embodiments, the method further includes:

in response to detecting a preset interaction operation on an item material corresponding to the target virtual item, displaying interaction confirmation information corresponding to the target virtual item and interaction effect indication information corresponding to the target virtual item; and

triggering the item interaction instruction in response to detecting an interaction confirmation operation based on the interaction confirmation information.

In some embodiments, the preset interaction operation can be set in conjunction with a practical application, such as a click, a long press, and other operations. The interaction effect indication information indicates at least one preset interaction effect corresponding to the target virtual item. In some embodiments, the interaction confirmation information is information for the user of a display terminal to confirm the triggering of the item interaction instruction.

Furthermore, it should be noted that in other embodiments, the item interaction instruction is directly triggered in response to detecting the preset interaction operation.

In the above embodiments, in the case that the preset interaction operation for the item material corresponding to the target virtual item is detected, and in the case that the interaction confirmation information corresponding to the target virtual item is displayed, displaying the interaction effect indication information corresponding to the target virtual item allows the user to know the service interaction effect brought by the interaction based on the target virtual item, such that the user can know the interaction effect and then trigger the item interaction instruction, thereby improving the user experience.

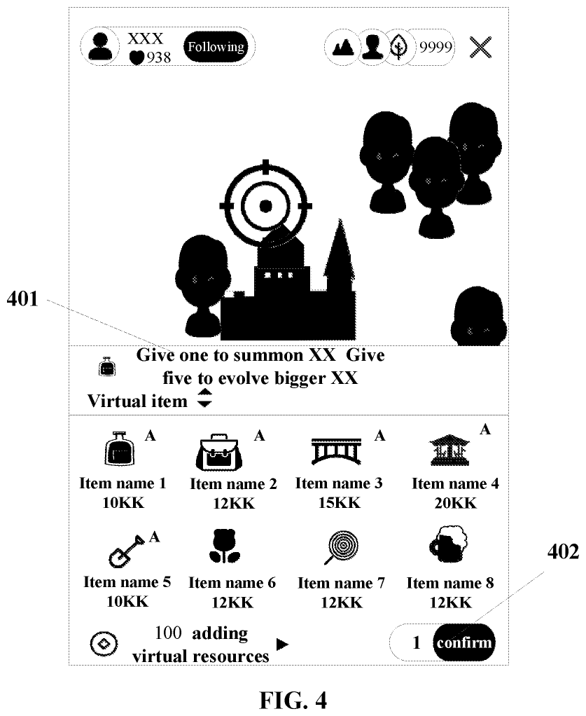

In some embodiments, referring to FIG. 3, assuming that the user performs a preset interaction operation on the virtual item corresponding to the “item name 1”, an interactive content live-streaming interface is displayed. In some embodiments, a virtual item panel is displayed in the interactive content live-streaming interface shown in FIG. 4, and interaction confirmation information 402 and interaction effect indication information 401 are displayed in the virtual item panel. In the illustrated example, the interaction effect indication information 401 describes the effect of giving virtual items, for example, “Give one to summon XX” “Give five to evolve bigger XX”. The interaction confirmation information 402 shows the quantity of virtual items to be given. In the illustrated example, the interaction confirmation information 402 shows that one (1) virtual item is given by triggering the button “confirm.” In some embodiments illustrated in FIG. 4, the item material with the identification “A” is the item material of the virtual item associated with the third-party application, and the item material without the identification “A” is the item material of the generic virtual item of the live-streaming platform and are not associated with the third-party application.

In the above embodiments, in the case that an item interaction instruction is triggered based on the item material corresponding to the target virtual item, updating the interactive content screen in the interactive content live-streaming interface in conjunction with the target interaction effect corresponding to the target virtual item can enhance the user's participation in the interaction service of the third-party application, and the user's enthusiasm for interacting based on the virtual item is improved.

In some embodiments, updating the interactive content screen in the interactive content live-streaming interface in response to triggering the item interaction instruction based on the item material corresponding to the target virtual item includes:

acquiring an upgraded item material of the target virtual item in response to triggering the item interaction instruction and a preset upgrade condition corresponding to the target virtual item being satisfied; and

updating the interactive content screen in the interactive content live-streaming interface and updating the item material of the target virtual item in the interactive content live-streaming interface to the upgraded item material.

In some embodiments, the preset upgrade condition corresponding to the target virtual item is a preset condition for the target virtual item to be upgraded, and is capable of being set in combination with a practical application. In some embodiments, for example, in the case that the cumulative quantity of gifts of the target virtual item reaches a preset threshold in the present live-streaming, it is determined that the preset upgrade condition is satisfied. In some embodiments, in the case that the item interaction instruction is triggered, the historical quantity of gifts of the target virtual item corresponding to the item interaction instruction in the present live-streaming is determined. In the case that the historical quantity of gifts reaches (is greater than or equal to) the preset quantity upon adding one to the historical quantity of gifts, the upgraded item material of the target virtual item is acquired, and in the case that the interactive content screen in the interactive content live-streaming interface is updated, the item material of the target virtual item in the interactive content live-streaming interface is updated to the upgraded item material. In some embodiments, the upgraded item material can be set in combination with a practical application, such as a small bottle upgraded to a large bottle. In some embodiments, in the case that the item material of the target virtual item is upgraded to the upgraded item material, the corresponding amount of item resources can also be upgraded, and the preset interactive effect can also be upgraded.

In the above embodiments, in the case that the item interaction instruction is triggered and the preset upgrade conditions corresponding to the target virtual item are satisfied, the upgraded item material of the target virtual item is acquired, and the item material of the target virtual item in the interactive content live-streaming interface is updated to the upgraded item material in the process of updating the interactive content screen in the interactive content live-streaming interface, such that the virtual item is enriched, and the enthusiasm and participation of the user to interact based on the virtual item are also enhanced, and the live-streaming atmosphere and interactivity are improved.

As can be seen from the technical solutions provided in the above embodiments of the present specification, in the embodiments of the present disclosure, in response to an interactive content live-streaming instruction for the third-party application, at least one item material of the virtual item associated with the third-party application is acquired, each of the item material of the virtual item is bound to a preset item position, and in the process of displaying the interactive content live-streaming interface corresponding to the third-party application, the item material of the virtual item is displayed at the preset item position in the interactive content live-streaming interface. The personalized configuration of virtual items for the third-party application is realized, the correlation between the virtual items and the third-party application in the process of live-streaming is enhanced, the users are facilitated to participate in the interaction service of the third-party application based on interaction of the virtual items, and the rate of participation in the interaction service of the users and the positivity of interaction based on the virtual items are increased. In this way, the live-streaming atmosphere and interactivity during the live-streaming of the interactive content of the third-party application are also improved.

In some embodiments, a method for processing virtual items in a live-streaming process is provided. The method is applicable to an electronic device that runs a third party application. The method includes:

sending via the live-streaming server, in response to an interactive content live-streaming instruction, a preset item identification corresponding to a preset item position to an application server of the third-party application, wherein the preset item identification is identification information of the preset item position, the application server matches each of the virtual items with a corresponding preset item position by establishing a correspondence between the item material of the virtual item and a preset item identification;

acquiring an item material of the virtual item and the preset item identification corresponding to the item material provided by the application server, wherein the virtual item associated with the third-party application matches at least one interaction service corresponding to the third-party application, and the interaction service is an interaction operation during an operation of the third party application, the item material of the virtual item includes description on the virtual item, and is bound to the preset item position while being displayed, wherein the virtual item is sent from an application server of the third-party application to a live-streaming server and acquired by the electronic device from a live-streaming server; and

displaying an interactive content live-streaming interface corresponding to the third-party application, and displaying the item material of the virtual item at the preset item position in the interactive content live-streaming interface based on the preset item identification corresponding to the item material, wherein the interactive content live-streaming interface is a live-streaming interface of an interactive content screen corresponding to the third party application.

In some embodiments, the method further includes displaying the item material of virtual item associated with the third-party application with an identification and displaying an item material of a generic virtual item of a live-streaming platform without the identification, wherein the generic virtual item is not associated with the third-party application.

In some embodiments of the method described above, the preset item position is a position of a generic virtual item in the live-streaming platform, and the item material of the virtual item is displayed at the position previously occupied by the generic item, wherein the generic virtual item is item resources not associated with the third-party application, wherein the preset item position is provided with a corresponding amount of item resources equivalent to the virtual item, wherein the preset item identification and the corresponding amount of item resources are sent to the application server of the third-party application via the live-streaming server, such that the application server is capable of establishing a correspondence between the item material of the virtual item and the corresponding preset item identification.

In some embodiments of the method described above, the preset item position is individually created for the virtual items associated with the third-party application, an amount of item resources corresponding to the preset item position is preset by the live-streaming platform or provided by the third-party application, in the case that the amount of item resources is provided by the third-party application, acquiring the item material of the virtual item and the preset item identification corresponding to the item material provided by the application server includes: acquiring the item material of the virtual item provided by the application server, the preset item identification corresponding to the item material, and the amount of item resources corresponding to the virtual item.

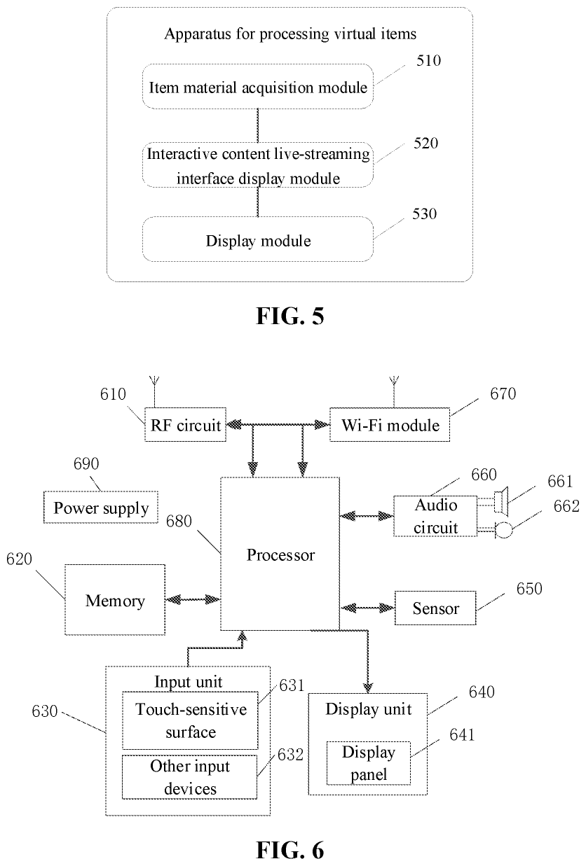

FIG. 5 is a block diagram of an apparatus for processing virtual items according to some embodiments of the present disclosure. Referring to FIG. 5, the device includes:

an item material acquisition module 510, configured to perform acquiring, in response to an interactive content live-streaming instruction to a third-party application, item material of at least one virtual item associated with the third-party application, wherein each of the item material of the virtual item is bound to a preset item position;

an interactive content live-streaming interface display module 520, configured to perform displaying an interactive content live-streaming interface corresponding to the third-party application; and

a display module 530, configured to perform displaying the item material of the virtual item at the preset item position in the interactive content live-streaming interface.

In some embodiments, the apparatus further includes:

a preset item identification sending module, configured to perform sending, in response to the interactive content live-streaming instruction, a preset item identification of the preset item position to an application server of the third-party application.

The item material acquiring module 510 is configured to perform acquiring the item material of the virtual item and the preset item identification corresponding to the item material provided by the application server.

The display module 530 is configured to perform displaying the item material of the virtual item at the preset item position in the interactive content live-streaming interface based on the preset item identification corresponding to the item material.

In some embodiments, the interactive content live-streaming interface display module 520 is configured to perform at least one of: displaying at least one preset item position in a visible interactive region of the interactive content live-streaming interface; and displaying at least one preset item position in a virtual item panel of the interactive content live-streaming interface.

In some embodiments, the at least one virtual item is matched with at least one interaction service corresponding to the third-party application, the at least one interaction service is a first interaction service currently run by the third-party application, and the at least one virtual item is at least one first virtual item matched with the first interaction service.

The display module 530 includes:

a first display unit, configured to perform displaying, at the preset item position in the interactive content live-streaming interface, an item material of the first virtual item.

In some embodiments, the apparatus further includes:

an item material updating module, configured to perform updating the item material of the first virtual item displayed at the preset item position in the interactive content live-streaming interface to an item material corresponding to a second virtual item, in response to the interaction service currently running in the third-party application being updated from the first interaction service to a second interaction service.

The second virtual item is matched with the second interaction service.

In some embodiments, the at least one virtual item is matched with at least one interaction service corresponding to the third-party application, the at least one interaction service includes a plurality of interaction services during running of the third-party application, and the display module 530 includes:

a second display unit, configured to perform displaying, at the preset item position in the interactive content live interface, item material of the virtual item and matched service identification information corresponding to the virtual item.

In some embodiments, the item material of the virtual item includes a target classification item material of the virtual item, the target classification item material is a classification item material matched with an object classification attribute of a target object of a plurality of classification item materials corresponding to the virtual item, and the target object is a user account of a display terminal corresponding to the interactive content live-streaming interface. The item material acquiring module 510 includes:

a target classification item material acquiring unit, configured to perform acquiring a target classification item material corresponding to the virtual item.

The display module 530 includes:

a target classification item material display unit, configured to perform displaying, at the preset item position in the interactive content live-streaming interface, the target classification item material of the virtual item.

In some embodiments, the first matching information between each of the plurality of classification item material corresponding to the virtual item and the matching object classification attribute is provided by the application server corresponding to the third-party application.

In some embodiments, the item material of the virtual item includes a designated item material, the designated item material is an item material being matched with a preset object, the preset object is an object whose application interaction attribute is a preset application interaction attribute.

The item material acquiring module 510 includes:

a designated item material acquiring unit, configured to perform acquiring the designated item material in response to the application interaction attribute corresponding to a target object is the preset application interaction attribute, wherein the target object is a user account of a display terminal corresponding to the interactive content live-streaming interface.

The display module 530 includes:

a designated item material display unit, configured to perform displaying, at the preset item position in the interactive content live-streaming interface, the designated item material.

In some embodiments, the second matching information between the designated item material and the preset application interaction attributes is provided by the application server corresponding to the third-party application.

In some embodiments, the at least one virtual item is matched with at least one interaction service corresponding to the third-party application, the virtual item corresponds to at least one preset interaction effect under the interaction service matched by the virtual item, and the apparatus further includes:

an interface update module, configured to perform updating an interactive content screen in the interactive content live-streaming interface in response to triggering an item interaction instruction based on an item material corresponding to a target virtual item.

The interactive content screen is updated based on a target interaction effect corresponding to the target virtual item, the target virtual item is any virtual item of the at least one virtual item, and the target interaction effect is a preset interaction effect of at least one preset interaction effect corresponding to the target virtual item.

In some embodiments, the interface update module includes:

an item interaction instruction sending unit, configured to perform sending the item interaction instruction to an application server of the third-party application in response to the item interaction instruction, wherein the item interaction instruction indicates performing a service interaction operation corresponding to the target interaction effect to update the interactive content screen; and

an interactive content screen updating unit, configured to perform updating the interactive content screen in the interactive content live-streaming interface based on updated interactive content information in response to receiving the updated interactive content information provided by the application server.

In some embodiments, the apparatus further includes:

an information display module, configured to perform in response to detecting a preset interaction operation on an item material corresponding to the target virtual item, displaying interaction confirmation information corresponding to the target virtual item and interaction effect indication information corresponding to the target virtual item, wherein the interaction effect indication information indicates at least one preset interaction effect corresponding to the target virtual item; and

an item interaction instruction triggering module, configured to perform triggering the item interaction instruction in response to detecting an interaction confirmation operation based on the interaction confirmation information.

In some embodiments, the interface updating module includes:

an upgrade item material acquiring unit, configured to perform acquiring an upgraded item material of the target virtual item in response to triggering the item interaction instruction and satisfying a preset upgrade condition corresponding to the target virtual item; and

an updating unit, configured to perform updating the interactive content screen in the interactive content live-streaming interface and updating the item material of the target virtual item in the interactive content live-streaming interface to the upgraded item material.

With respect to the apparatus in the above embodiments, the specific manner of each of the modules to perform an operation has been described in detail in the embodiments related to the method, and is not repeated in detail herein.

FIG. 6 is a block diagram of an electronic device for processing virtual items according to some embodiments of the present disclosure. The electronic device is a terminal, and an internal structure diagram of the electronic device is shown in FIG. 6. The terminal includes a radio frequency (RF) circuit 610, a memory 620 including one or more computer-readable storage medium, an input unit 630, a display unit 640, a sensor 650, an audio circuit 660, a wireless fidelity (Wi-Fi) module 670, a processor 670 including one or more processing cores, a processor 680, and a power supply 690, and other components. It is appreciated by those skilled in the art that the terminal structure illustrated in FIG. 6 does not constitute a limitation of the terminal, and the terminal can include more or fewer components than illustrated, or a combination of certain components, or a different arrangement of components.

RF circuitry 610 is configured to receive and transmit signals during sending and receiving messages or calls, in particular, to receive downlink information from a base station and then hand it over to one or more processors 680 for processing, and to send data involving uplink to the base station. Typically, an RF circuitry 610 includes, but is not limited to, an antenna, at least one amplifier, a tuner, one or more oscillators, a subscriber identity module (SIM) card, a transceiver, a coupler, a low noise amplifier (LNA), a duplexer, and the like. In addition, the RF circuitry 610 communicates with networks and other terminals via wireless communication. The wireless communication uses any of a number of communication standards or protocols, including but not limited to global system of mobile communication (GSM), general packet radio service (GPRS), code division multiple access (CDMA), wideband code division multiple access (WCDMA), long term evolution (LTE), e-mail, short messaging service (SMS), and the like.

The memory 620 is configured to store software programs as well as modules, and the processor 680 performs various functional applications and data processing by running the software programs and modules stored in the memory 620. The memory 620 primarily includes a storage program region and a storage data region. The storage program region stores the operating system, the applications required for the functions, and the like. The storage data region stores the data created based on the use of the terminal, and the like. In addition, the memory 620 includes a high-speed random access memory and a non-transitory memory, such as at least one disk memory device, a flash memory device, or other volatile solid-state memory device. Accordingly, the memory 620 also includes a memory controller to provide access to the memory 620 by the processor 680 and the input unit 630.

The input unit 630 is configured to receive incoming numeric or character information, and to generate keyboard, mouse, joystick, optical, or trackball signal inputs related to user settings as well as function control. Specifically, the input unit 630 includes a touch-sensitive surface 631 and other input devices 632. The touch-sensitive surface 631, also referred to as a touch display or touch pad, collects user touch operations on or near it (e.g., user operations using any suitable object or accessory such as a finger, stylus, or the like, on or near the touch-sensitive surface 631) and actuate the corresponding connecting device based on a preset program. In some embodiments, the touch-sensitive surface 631 includes a touch detection device and a touch controller. The touch detection device detects the touch orientation of the user and detects the signal brought by the touch operation, and transmits the signal to the touch controller. The touch controller receives the touch information from the touch detection device and converts the touch information into the contact coordinates, and then sends the touch information to the processor 680, and is able to receive the instructions from the processor 680 and execute the instructions. In addition, the touch-sensitive surface 631 can be realized using various types such as resistive, capacitive, infrared, and surface acoustic wave, and the like. In addition to the touch-sensitive surface 631, the input unit 630 can also include other input devices 632. Specifically, the other input devices 632 can include, but are not limited to, one or more of physical keyboards, function keys (e.g., volume control keys, on/off keys), trackballs, mice, joysticks, and the like.

The display unit 640 is configured to display information entered by the user or provided to the user and various graphical user interfaces of the terminal. The interfaces include graphics, text, icons, video, and any combination thereof. The display unit 640 includes a display panel 641. In some embodiments, the display panel 641 is configured in the form of a liquid crystal display (LCD), an organic light-emitting diode (OLED), or the like. Further, the touch-sensitive surface 631 covers the display panel 641, and upon detecting a touch operation on or close to the display panel 641, the touch-sensitive surface 631 transmits to the processor 680 to determine a type of touch event, and the processor 680 subsequently provides a corresponding visual output on the display panel 641 based on the type of touch event. The touch-sensitive surface 631 and the display panel 641 are two separate components to implement the input and input functions, but in some embodiments, the touch-sensitive surface 631 can also be integrated with the display panel 641 to implement the input and output functions.

The terminal includes at least one sensor 650, such as a light sensor, a motion sensor, and other sensors. Specifically, the light sensor includes an ambient light sensor and a proximity sensor, wherein the ambient light sensor adjusts the brightness of the display panel 641 based on the brightness of the ambient light, and the proximity sensor turns off the display panel 641 and/or the backlighting in the case that the terminal is moved to the car. As a kind of motion sensor, the gravity acceleration sensor can detect the size of acceleration in all directions (generally three-axis), and the size and direction of gravity can be detected in stationary, which can be used to recognize the application of terminal posture (such as horizontal and vertical screen switching, related games, magnetometer posture calibration), vibration recognition related functions (such as pedometer, knocking), and the like. The terminal may also be configured with a gyroscope, a barometer, a hygrometer, a thermometer, an infrared sensor, or another other sensor, which is not repeated herein.

The audio circuit 660, the speaker 661, and the microphone 662 provide an audio interface between the user and the terminal. The audio circuit 660 converts received audio data converted into electrical signals and transmits the electrical signals to the speaker 661, and the speaker 661 converts them to sound signals for output. In addition, the microphone 662 converts the collected sound signals into electrical signals, the audio circuit 600 receives the electrical signals and converts the electrical signals to audio data. The audio data is then processed by the audio data output processor 680 and subsequently processed by the RF circuit 610 and sent to, for example, another terminal, or the audio data is output to the memory 620 for further processing. The audio circuitry 660 also includes an earbud jack to provide communication between a peripheral headset and the terminal.

Wi-Fi is a short-range wireless transmission technology, and using the Wi-Fi module 670, the terminal helps users send and receive e-mails, browse webs, and access streaming media, which provides users with wireless broadband Internet access. Although the Wi-Fi module 670 is illustrated in FIG. 6, it should be understood that it is not a necessary component of the terminal, and may be omitted according to actual needs within the extent of not altering the essence of the present disclosure.

The processor 680 is a control center of the terminal, connects various parts of the terminal using various interfaces and lines, and performs various functions and processes data of the terminal by running or executing software programs and/or modules stored in the memory 620 and by calling up data stored in the memory 620, thereby monitoring the terminal as a whole. In some embodiments, the processor 680 includes one or more processing cores. Preferably, the processor 680 integrates an application processor and a modem processor. The application processor mainly handles the operating system, the user interface, the application programs, and the like. The modem processor mainly handles the wireless communication. It is appreciated that the modem processor may not be integrated into the processor 680 either.

The terminal also includes a power supply 690 (e.g., a battery) that supplies power to the various components. Exemplarily, the power supply 690 is logically connected to the processor 680 via a power management system, such that functions such as charging and discharging management, and power consumption management are implemented using the power management system. The power supply 690 also includes one or more DC or AC power sources, a re-charging system, a power failure detection circuit, a power converter or inverter, a power status indicator, and any other component.

Although not shown, the terminal also includes a camera, a Bluetooth module, and the like, which is not described herein. Specifically in the embodiment, the display unit of the terminal is a touch screen display, and the terminal further includes a memory, and one or more programs, wherein the one or more programs are stored in the memory and are configured to execute instructions in the method embodiment of the present invention by the one or more processors.

In exemplary embodiments, an electronic device is also provided, including: a processor; a memory configured to store one or more instructions executable by the processor. The processor. when loading and executing the one or more instructions, is caused perform a method for processing virtual items as described in embodiments of the present disclosure.

In exemplary embodiments, a non-transitory computer-readable storage medium is also provided. One or more instructions in the storage medium, when loaded and executed by a processor of an electronic device, cause the electronic device to perform the method for processing virtual items as described in the embodiments of the present disclosure.

In exemplary embodiments, a computer program product is also provided, including one or more instructions, when run on a computer, cause the computer to perform the method for processing virtual items as described in the embodiments of the present disclosure.

A person of ordinary skill in the art can understand that realizing all or part of the processes in the methods of the above embodiments is possible to be accomplished by instructing the relevant hardware through a computer program, which is stored in a non-transitory computer-readable storage medium, and which, when executed, includes a process such as the processes of the embodiments of the above methods. Any reference to a memory, storage, database, or other medium used in the embodiments provided in the application includes non-transitory and/or transitory memory. Non-transitory memory includes read-only memory (ROM), programmable ROM (PROM), electrically programmable ROM (EPROM), electrically erasable programmable ROM (EEPROM), or flash memory. The transitory memory includes a random access memory (RAM) or an external cache memory. By way of illustration rather than limitation, the RAM is available in a plurality of forms, such as a static RAM (SRAM), a dynamic RAM (DRAM), a synchronous DRAM (SDRAM), a double data rate SDRAM (DDRSDRAM), an enhanced SDRAM (ESDRAM), a synchlink DRAM (SLDRAM), a Rambus direct RAM (RDRAM), a direct Rambus dynamic RAM (DRDRAM), and a Rambus dynamic RAM (RDRAM).

All embodiments of the present disclosure may be performed alone or in combination with other embodiments and are considered to be within the scope of protection of the claims of the present disclosure.

What is claimed is:

1. A method for processing virtual items in a live-streaming process, applicable to an electronic device that runs a third-party application, comprising:
acquiring, in response to an interactive content live-streaming instruction to the third-party application, an item material of at least one virtual item associated with the third-party application, wherein the virtual item associated with the third-party application matches at least one interaction service corresponding to the third-party application, and the interaction service is an interaction operation during running of the third-party application, the item material of the virtual item includes description on the virtual item, and is bound to a preset item position while being displayed; and
displaying an interactive content live-streaming interface corresponding to the third-party application, and displaying the item material of the virtual item at the preset item position in the interactive content live-streaming interface,
wherein the interactive content live-streaming interface is a live-streaming interface of an interactive content screen corresponding to the third-party application.

2. The method according to claim 1, further comprising:
sending via a live-streaming server, in response to the interactive content live-streaming instruction, a preset item identification corresponding to the preset item position to an application server of the third-party application, wherein the preset item identification is identification information of the preset item position;
wherein said acquiring the item material of the at least one virtual item associated with the third-party application comprises:
acquiring the item material of the virtual item and the preset item identification corresponding to the item material provided by the application server; and
said displaying the item material of the virtual item at the preset item position in the interactive content live-streaming interface comprises:
displaying the item material of the virtual item at the preset item position in the interactive content live-streaming interface based on the preset item identification corresponding to the item material.

3. The method according to claim 2, wherein the preset item position is a position of a generic virtual item in a live-streaming platform, and the item material of the virtual item is displayed at the position previously occupied by the generic virtual item, wherein the generic virtual item is item resources not associated with the third-party application, wherein the preset item position is provided with a corresponding amount of item resources equivalent to the virtual item, wherein the preset item identification and the corresponding amount of item resources are sent to the application server of the third-party application via the live-streaming server, such that the application server is capable of establishing a correspondence between the item material of the virtual item and the corresponding preset item identification.

4. The method according to claim 2, the preset item position is individually created for the virtual items associated with the third-party application, an amount of item resources corresponding to the preset item position is preset by a live-streaming platform or provided by the third-party application, in the case that the amount of item resources is provided by the third-party application, acquiring the item material of the virtual item and the preset item identification corresponding to the item material provided by the application server includes: acquiring the item material of the virtual item provided by the application server, the preset item identification corresponding to the item material, and the amount of item resources corresponding to the virtual item.

5. The method according to claim 1, wherein said displaying the interactive content live-streaming interface corresponding to the third-party application comprises at least one of:
displaying the item material of the virtual item at the preset item position in a visible interactive region of the interactive content live-streaming interface; and
displaying the item material of the virtual item at the preset item position in a virtual item panel of the interactive content live-streaming interface.

6. The method according to claim 1, wherein
the at least one interaction service is a first interaction service currently run by the third-party application, and the at least one virtual item is at least one first virtual item matched with the first interaction service; and
said displaying the item material of the virtual item at the preset item position in the interactive content live-streaming interface comprises:
displaying, at the preset item position in the interactive content live-streaming interface, an item material of the first virtual item.

7. The method according to claim 6, further comprising:
in response to an interaction service currently running in the third-party application being updated from the first interaction service to a second interaction service, updating the item material of the first virtual item displayed at the preset item position in the interactive content live-streaming interface to an item material corresponding to a second virtual item;
wherein the second virtual item is matched with the second interaction service.

8. The method according to claim 1, wherein
the at least one interaction service comprises a plurality of interaction services during running of the third-party application; and
said displaying the item material of the virtual item at the preset item position in the interactive content live-streaming interface comprises:
displaying, at the preset item position in the interactive content live-streaming interface, the item material of the virtual item and matched service identification information corresponding to the virtual item, wherein the matched service identification information identifies the interaction service matched with the virtual item.

9. The method according to claim 1, wherein
the item material of the virtual item comprises a target classification item material of the virtual item, the target classification item material is a classification item material matched with an object classification attribute of a target object of a plurality of classification item materials corresponding to the virtual item, and the target object is a user account of a display terminal corresponding to the interactive content live-streaming interface;
said acquiring the item material of the at least one virtual item associated with the third-party application comprises:
acquiring a target classification item material of the virtual item; and
said displaying the item material of the virtual item at the preset item position in the interactive content live-streaming interface comprises:
displaying, at the preset item position in the interactive content live-streaming interface, the target classification item material of the virtual item.

10. The method according to claim 9, further comprising:
acquiring first matching information provided by an application server of the third-party application, wherein the first matching information indicates matching between each of the plurality of classification item materials corresponding to the virtual item and a matched object classification attribute.

11. The method according to claim 1, wherein
the item material of the virtual item comprises a designated item material, the designated item material is an item material being matched with a preset object, the preset object is an object whose application interaction attribute is a preset application interaction attribute;
said acquiring the item material of the at least one virtual item associated with the third-party application comprises:
acquiring the designated item material in response to the application interaction attribute corresponding to a target object is the preset application interaction attribute, wherein the target object is a user account of a display terminal corresponding to the interactive content live-streaming interface; and
said displaying the item material of the virtual item at the preset item position in the interactive content live-streaming interface comprises:
displaying, at the preset item position in the interactive content live-streaming interface, the designated item material.

12. The method according to claim 11, further comprising:
acquiring second matching information provided by an application server of the third-party application, wherein the second matching information indicates matching between the designated item material and the preset application interaction attribute.

13. The method according to claim 1, wherein
the virtual item corresponds to at least one preset interaction effect under the interaction service matched by the virtual item; and
the method further comprises:
updating an interactive content screen in the interactive content live-streaming interface in response to triggering an item interaction instruction based on an item material corresponding to a target virtual item;
wherein the interactive content screen is updated based on a target interaction effect corresponding to the target virtual item, the target virtual item is any virtual item of the at least one virtual item, and the target interaction effect is a preset interaction effect of at least one preset interaction effect corresponding to the target virtual item, wherein the preset interaction effect represents an influence of an interaction on the matched interaction service.

14. The method according to claim 13, wherein said updating the interactive content screen in the interactive content live-streaming interface in response to triggering the item interaction instruction based on the item material corresponding to the target virtual item comprises:
sending the item interaction instruction to an application server of the third-party application in response to the item interaction instruction, wherein the item interaction instruction indicates performing a service interaction operation corresponding to the target interaction effect to update the interactive content screen; and
updating the interactive content screen in the interactive content live-streaming interface based on updated interactive content information in response to receiving the updated interactive content information provided by the application server and transmitted via a live-streaming server.

15. The method according to claim 14, further comprising:
in response to detecting a preset interaction operation on an item material corresponding to the target virtual item, displaying interaction confirmation information corresponding to the target virtual item and interaction effect indication information corresponding to the target virtual item, wherein the interaction confirmation information is information for a user to confirm triggering of the item interaction instruction, and the interaction effect indication information indicates at least one preset interaction effect corresponding to the target virtual item; and
triggering the item interaction instruction in response to detecting an interaction confirmation operation based on the interaction confirmation information.

16. The method according to claim 13, wherein said updating the interactive content screen in the interactive content live-streaming interface in response to triggering the item interaction instruction based on the item material corresponding to the target virtual item comprises:
acquiring an upgraded item material of the target virtual item in response to triggering the item interaction instruction and a preset upgrade condition corresponding to the target virtual item being satisfied; and
updating the interactive content screen in the interactive content live-streaming interface and updating the item material of the target virtual item in the interactive content live-streaming interface to the upgraded item material.

17. An electronic device, comprising:
a processor; and
a memory, configured to store one or more instructions executable by the processor;
wherein the processor, when loading and executing the one or more instructions, is caused to perform a method for processing virtual items in a live-streaming process, and is caused to:
acquire, in response to an interactive content live-streaming instruction to a third-party application, item material of at least one virtual item associated with the third-party application, wherein the virtual item associated with the third-party application matches at least one interaction service corresponding to the third-party application, and the interaction service is an interaction operation during running the third-party application, each of the item materials of the virtual item is bound to a preset item position while being displayed; and
display an interactive content live-streaming interface corresponding to the third-party application and display the item material of the virtual item at the preset item position in the interactive content live-streaming interface,
wherein the interactive content live-streaming interface is a live-streaming interface of an interactive content screen corresponding to the third-party application.

18. The electronic device according to claim 17, wherein the processor, when loading and executing the one or more instructions, is caused to:
send via a live-streaming server, in response to the interactive content live-streaming instruction, a preset item identification corresponding to the preset item position to an application server of the third-party application, wherein the preset item identification is identification information of the preset item position;
acquire the item material of the virtual item and the preset item identification corresponding to the item material provided by the application server; and
display the item material of the virtual item at the preset item position in the interactive content live-streaming interface based on the preset item identification corresponding to the item material.

19. The electronic device according to claim 17, wherein the processor, when loading and executing the one or more instructions, is caused to:
display the item material of the virtual item at the preset item position in a visible interactive region of the interactive content live-streaming interface; and
display the item material of the virtual item at the preset item position in a virtual item panel of the interactive content live-streaming interface.

20. The electronic device according to claim 17, wherein
the at least one interaction service is a first interaction service currently running in the third-party application, and the at least one virtual item is at least one first virtual item matched with the first interaction service; and
the processor, when loading and executing the one or more instructions, is caused to:
display, at the preset item position in the interactive content live-streaming interface, an item material of the first virtual item.

21. The electronic device according to claim 20, the processor, when loading and executing the one or more instructions, is caused to:
update the item material of the first virtual item displayed at the preset item position in the interactive content live-streaming interface to an item material corresponding to a second virtual item, in response to the interaction service currently running in the third-party application being updated from the first interaction service to a second interaction service;
wherein the second virtual item is matched with the second interaction service.

22. A non-transitory computer-readable storage medium, wherein one or more instructions in the storage medium, when loaded and executed by a processor of an electronic device, cause the electronic device to perform a method for processing virtual items in a live-streaming process, and is caused to:
acquire, in response to an interactive content live-streaming instruction to a third-party application, item material of at least one virtual item associated with the third-party application, wherein the virtual item associated with the third-party application matches at least one interaction service corresponding to the third-party application, and the interaction service is an interaction operation during running the third-party application, each of the item materials of the virtual item is bound to a preset item position while being displayed; and
display an interactive content live-streaming interface corresponding to the third-party application and display the item material of the virtual item at the preset item position in the interactive content live-streaming interface,
wherein the interactive content live-streaming interface is a live-streaming interface of an interactive content screen corresponding to the third-party application.
